(19) United States
(12) Patent Application Publication
(10) Pub. No.: US 2023/0359697 A1
(43) Pub. Date: Nov. 9, 2023

(54) TENSOR PROCESSING

(71) Applicants: Douyin Vision Co., Ltd., Beijing (CN); Lemon Inc., Grand Cayman (KY)

(72) Inventors: Chengquan Jiang, Beijing (CN); Xiaoying Jia, Beijing (CN); Xin Liu, Beijing (CN); Yujia Zhai, Los Angeles, CA (US)

(21) Appl. No.: 18/354,471

(22) Filed: Jul. 18, 2023

(51) Int. Cl. G06F 17/16

(52) U.S. Cl. CPC G06F 17/16

(57) ABSTRACT

A method is proposed for tensor processing. A first tensor is obtained to be applied attention, the first tensor representing a batch of inputs with variable sequence lengths. The first tensor is divided into a plurality of matrices based on the number of inputs of the batch and the number of heads of the attention, wherein a matrix of the plurality of matrices has a dimension corresponding to the sequence length of an input of the batch and a dimension corresponding to a head size of the attention. A second tensor is generated by applying the attention to the plurality of matrices respectively based on a grouped matrix multiplication, wherein a resulting matrix of the grouped matrix multiplication comprises a plurality of tiles each of which is computed by a set of threads with a shared memory. Therefore, the computations on useless tokens are avoided.

### FIELD

The present disclosure generally relates to tensor processing, and more specifically, to methods, devices, and computer program products for tensor processing.

### BACKGROUND

Nowadays, the Transformer model has been widely used in a variety of deep learning (DL) applications, such as language modeling, neural machine translation and recommendation systems. The last decade has witnessed rapid developments in natural language processing (NLP) pre-training models based on the Transformer model, which have also greatly accelerated the progress of NLP. Of all the pretraining models based on Transformers, Bidirectional Encoder Representations from Transformers (BERT) is outperforming reference models on a dozen NLP tasks at the time of creation. However, BERT-like models consume increasingly larger parameter space and correspondingly more computational resources. This increases the cost of the training and inference for BERT-like models. In this situation, how to accelerate these models becomes a hot focus.

### SUMMARY

In a first aspect of the present disclosure, there is provided a method for tensor processing. In the method, a first tensor is obtained to be applied attention, the first tensor representing a batch of inputs with variable sequence lengths. The first tensor is divided into a plurality of matrices based on the number of inputs of the batch and the number of heads of the attention, wherein a matrix of the plurality of matrices has a dimension corresponding to the sequence length of an input of the batch and a dimension corresponding to a head size of the attention. A second tensor is generated by applying the attention to the plurality of matrices respectively based on a grouped matrix multiplication, wherein a resulting matrix of the grouped matrix multiplication comprises a plurality of tiles each of which is computed by a set of threads with a shared memory. Therefore, the computations on useless tokens are avoided.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some embodiments of the present disclosure in the accompanying drawings, the above and other objects, features, and advantages of the present disclosure will become more apparent, wherein the same reference generally refers to the same components in the some embodiments of the present disclosure.

FIG. 1 illustrates a schematic diagram of an example architecture of Transformer;

FIG. 2A illustrates a schematic diagram of a basic architecture of a Transformer encoder according to some embodiments of the present disclosure;

FIG. 2B illustrates a schematic diagram of Transformer encoder architecture with kernel fusion optimization according to some embodiments of the present disclosure;

FIG. 2C illustrates a schematic diagram of Transformer encoder architecture with kernel fusion and padding-free optimization according to some embodiments of the present disclosure;

FIG. 3 illustrates a schematic diagram of padding-free algorithm according to some embodiments of the present disclosure;

FIG. 4 illustrates a schematic diagram of grouped General Matrix Multiplication (GEMM) demonstration according to some embodiments of the present disclosure;

FIG. 5 illustrates a schematic diagram of Grouped-GEMM-based fused multi-head attention (MHA) according to some embodiments of the present disclosure;

FIG. 6 illustrates a schematic diagram of Warp prefetching for grouped GEMM according to some embodiments of the present disclosure;

FIG. 7 illustrates a schematic diagram of fused softmax reduction in grouped GEMM epilogue according to some embodiments of the present disclosure;

FIG. 8 illustrates an example flowchart of a method for tensor processing according to some embodiments of the present disclosure; and

FIG. 9 illustrates a block diagram of a computing device in which various some embodiments of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As used herein, the term “kernel” refers to machine executable codes which when executed perform one or more operations. For example, a central processing unit (CPU) may launch a kernel to a graphic processing unit (GPU).

As used herein, if two or more operations are fused, it means that these operations can be performed by a same kernel without accessing a global memory for more than one time. A kernel for performing fused operations may be referred to as a fused kernel.

As used herein, the term “epilogue” may refer to an ending part of a kernel, for example a fused kernel. The epilogue may be used for post-processing. The term “prologue” may refer to a beginning part of a kernel, for example a fused kernel. The prologue may be used for pre-processing.

In the present disclosure, hidden_dim denotes the size of the hidden dimension, head_num denotes the number of heads of attention (which is also referred to as head number) or an attention mechanism, and head_size denotes the size of the hidden dimension per head, which is also referred to as head size. Moreover, hidden_dim equals to head_num×head_size. The term “batch size” or batch size denotes the number of inputs in a batch of inputs. The term “sequence length” or seq_len denotes a length of the sequence of an input. For example, if an input is a sentence with 5 words, the sequence length is 5.

As used herein, the term “thread block”, which is represented by CTA, refers to a set of threads (for example, of the GPU) with a shared memory. Accordingly, the threads in the thread block can access data or instructions in the shared memory without accessing a global memory. The term “thread warp” or “warp” may refer to a subset of the threads in the thread blocks. For example, the warp may include 32 threads. The threads in the warp can perform inter-thread communication within the thread, and thus can communicate with other during execution efficiently.

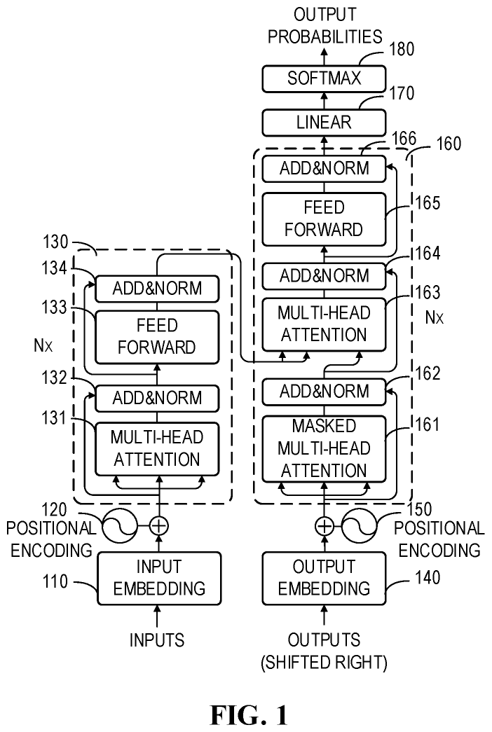

FIG. 1 illustrates a schematic diagram of an encode-decoder model architecture of the Transformer. The Transformer comprises stacks of multiple encode and decoder layers. The input tensors are processed in an input embedding layer 110. After being performed positional encoding at the layer 120, they are sent to the encoder with the block 130 repeated for N times. The block 130 includes a multi-head attention layer 131 followed by a feed-forward network (FFN) layer 133. A layer normalization operation, such as adding bias and normalization (add & norm) layer 132 and add & norm layer 133, is applied after both the MHA layer 131 and the FFN layer 133.

In FIG. 1, the output tensors which are shifted right are processed in an output embedding layer 140. After being performed positional encoding at the layer 150, they are sent to the decoder with a block 160 repeated for N times. The block 160 include two sets of consecutive MHA layers (such as masked multi-head attention layer 161 and multi-head attention layer 163) and one FFN layer 165, and each operation is normalized at the add & norm layer 162, add & norm layer 164 and add & norm layer 166. Then, probabilities are output via the linear layer 170 and softmax layer 180.

Although both encoder and decoder for the Transformer are showed in FIG. 1, a model based on Transformer may include either the encoder or the decoder, or may include a portion of the encode or the decoder.

Self-attention is a key module of the Transformer architecture. Conceptually, self-attention computes the significance of each position of the input sequence, with the information from other positions considered. A self-attention receives three input tensors: query (Q), key (K), and value (V). Self-attention can be split into multiple heads. The Q and K tensors are first multiplied (which is also referred to as 1^{st} GEMM) to compute the dot product of the query against all keys. This dot product is then scaled by the hidden dimension dₖ and passed through a softmax operation to calculate the weights corresponding to the value tensor. Each head of the output tensor is concatenated before going through another linear layer by multiplying against tensor V (which is also referred to as 2^{nd} GEMM). The self-attention may be expressed as a mathematical formula as following:

$$Attention ( Q , K , V ) = softmax ( \frac{{QK}^{T}}{\sqrt{{d}_{k}}} ) \times V \qquad ( 1 )$$

where the formula of multi-head attention is: Multihead(Q, K, V)=Concat(headᵢ, . . . , headₕ), here headᵢ=Attention(Qᵢ, Kᵢ, Vᵢ).

In the present disclosure, some embodiments below are described with respect to the encoder or a portion thereof, which can be extended to other models including the decoder. Moreover, although some embodiments are described with respect to MHA, it is to be understand that the tensor processing solution of the present disclosure is applicable to a single head attention.

### Operation Fusion and Padding-Free

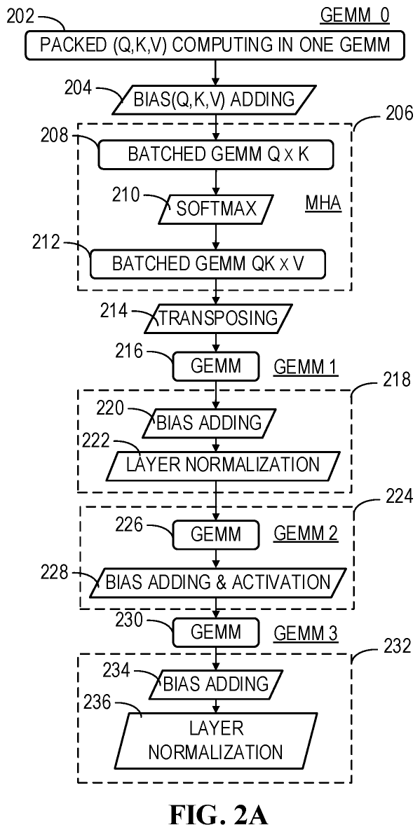

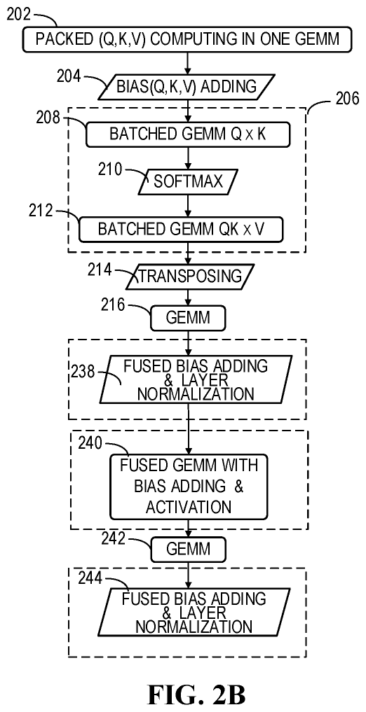

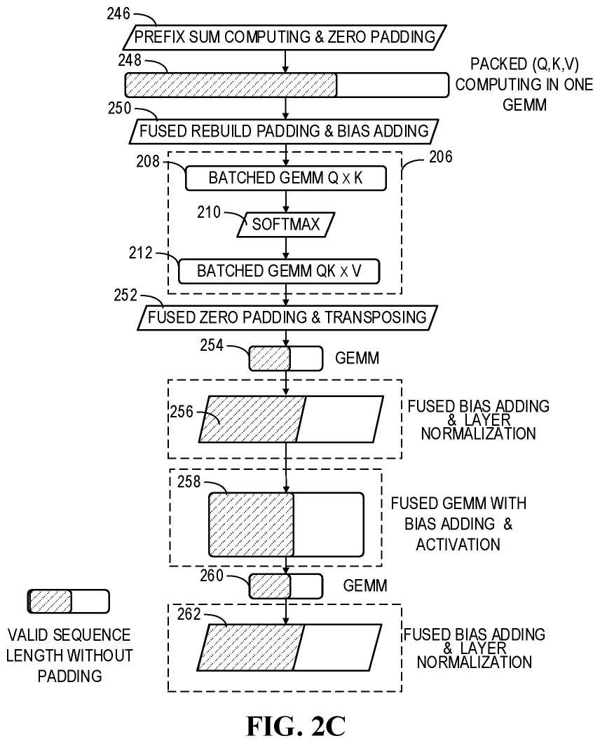

To better understand the solution for tensor processing of the present disclosure, some examples in terms of algorithmic and kernel-level optimizations are now described. FIG. 2A illustrates a schematic diagram of a basic architecture of the Transformer encoder. In FIG. 2A and subsequent FIG. 2B and 2C, the standard BERT Transformer encoder is shown as an example for purpose of illustration without any limitation. The tensor processing solution of the present disclosure may be applied to any suitable structure with attention, specifically self-attention.

The input tensor is first processed through the pipeline, where it is multiplied by a built-in attribute matrix to perform Q, K, and V positioning encoding. This operation can be implemented using three separate GEMM operations or in batch mode. Because the corresponding attribute matrices to Q, K, and V are all the same shape (which is denoted as hidden_dim×hidden_dim), they are packed to continuous memory space and launch a single batched GEMM kernel that calculates Q, K, and V to reduce the kernel launch overhead at runtime. Bias matrices for Q, K, and V are then added to the encoded tensor, which is passed through the self-attention module.

In some embodiments of the present disclosure, the attention is part of a model based on Transformer. The following will describe the BERT Transformer based on the multi head attention mechanism as an example.

In FIG. 2A, the BERT Transformer encoder comprises an MHA module, a projection module, a feed forward network and a layer normalization module. The MHA module 206 comprises two batched GEMM layers and one softmax layer. The encoder pipeline can be represented as a series of mathematical operations, including a few GEMMs (shown in rectangular blocks) and other memory-bound operations (shown in parallelogram blocks).

Specifically, at block 202, the packed input tensor (Q, K, V) is computed in GEMM #0. At block 204, the bias (Q, K, V) is added. At block 208, the batched GEMM for Q and K tensors are performed. At block 210, a softmax operation is used to calculate the weights corresponding to the value tensor. At block 212, the batched GEMM for Q×K and V tensors are performed. The output tensor is transposed at block 214 and GEMM #1 is performed at block 216.

Further, at block 220, the bias is added to the tensors. At block 222, the layer normalization is performed. Then, GEMM #2 is performed at block 226, bias adding and activation is performed at block 228. At block 230, GEMM #3 is performed. Subsequently, the bias is added at block 234 and layer normalization is performed at block 236.

In FIG. 2A, the MHA module 206 is the most time-consuming part of the Transformer for example, nearly half or more than half of the total execution time. To exploit hardware efficiency, some solutions adopt a batching strategy, where multiple batches are executed concurrently. Since batched execution requires task shapes in different batches to be identical, fixed-length inputs are presumed when designing the software. However, this assumption cannot always hold, because the Transformer models are often faced with variable-length input problems. In order to deploy models with variable-length inputs directly to conventional frameworks that support only fixed-length models, a straightforward solution is to pad all sequences with zeros to the maximal sequence length. However, this immediately brings in redundant computations on wasted padded tokens. These padded zeros also introduce significant memory overhead that can hinder a large Transformer model from being efficiently deployed.

To lift the restriction on fixed sequence lengths, some solutions provide explicit support for models with variable sequence lengths. Sequences with similar lengths are grouped before launching batched kernels to minimize the padding overhead. However, this proactive grouping approach still introduces irremovable padding overhead when grouping and padding sequences with similar yet different lengths.

In contrast to training processes that can be computed offline, the inference stage of a serving system must be processed online with low latency. A highly efficient solution for NLP models requires delicate kernel level optimizations and explicit end-to-end designs to avoid wasted computations on zero tokens when handling variable length inputs. However, existing solutions do not meet these expectations.

The modules containing memory-bound operations may be optimized, such as feed forward network (with layer normalizing) and bias adding followed by elementwise activation. In some embodiments, these memory-bound operations may be improved by fusing distinct kernels and reusing data in registers to reduce global memory access.

FIG. 2B illustrates a schematic diagram of Transformer architecture encoder with kernel fusion optimization according to some embodiments of the present disclosure. In this example, memory-bound operations are optimized by kernel fusion. For example, layer normalization and activation are fused with their respective consecutive kernels.

In FIG. 2B, compared with the example embodiment of FIG. 2A, the block 218 is replaced by the block 238 and the block 232 is replaced by the block 244. That is, those tensors go through two layers fused bias adding and layer normalizing.

The BERT Transformer is composed of a series of GEMM and memory-bound operations. The result tensor needs to be added by the input tensor and normalized after projection and feed forward network of BERT Transformer. Rather than launching two separated kernels, these operations may be fused into a single kernel and re-use data at the register level. In addition to kernel fusion, the computational throughput of layer normalization is increased by assigning more workload to each thread.

Comparing FIG. 2A without fusion to FIG. 2B, the block 224 is replaced by the block 240. That is, GEMM is fused with bias adding and activation. In this way, a fused kernel is provided to reduce the global memory access. By contrast, an unfused implementation would call the GEMM, store the output to global memory, and then load the result matrix from global memory for further element-wise operations. By fusing the operations into a single kernel, the result matrix of GEMM is held in registers, and thus those fused element-wise operations are conducted by re-using data at the register level. Once the element-wise transform (for example, adding bias and activation) is completed, the results are stored to the global memory.

At block 238 and block 244, fused bias adding and normalization are performed. After MHA, the result tensor (which has a size denoted as valid_word_{cnt}×hidden_dim) needs to first be added upon the input tensor (bias) and perform layer normalization.

In standard BERT configuration, head number and head size may be fixed to 12 and 64 for example. The naive implementation introduces two rounds of memory access to load and store the tensor. In some embodiments, a fused kernel that only needs to access the global memory in one round to finish both layer normalizing and bias adding may be provided. Kernel fusion for this sub kernel can improve the performance of the Transformer encoder.

At block 240, fused GEMM with bias adding and activation is performed. After the projection via matrix multiplication, the result tensor will be added against the input tensor and perform an element-wise activation. The fused implementation, rather than storing the GEMM output to global memory and loading it again to conduct adding bias and activation, re-uses the GEMM result matrix at the register level by implementing a customized and fused epilogue.

Because the real-time serving process receives sentences with various words as input tensor, the sequence lengths of the input sentences can often be different among batches, even within a batch. For such an input tensor composed of sentences with variable lengths, the conventional solution is to pad them to the maximal sequence length with useless tokens, which leads to significant computational and memory overhead.

In order to address this issue, in some embodiments, the padding-free algorithm may be used to pack the input tensor and store the positioning information for other Transformer operations to index the original sequences.

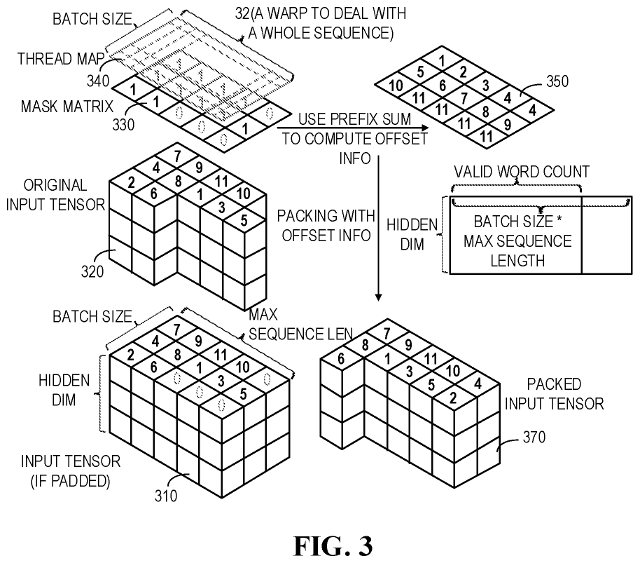

Reference is now made to FIG. 3, which illustrates a schematic diagram of padding-free algorithm according to some embodiments of the present disclosure. The example embodiment of FIG. 3 presents an example of the padding-free algorithm. An original input tensor 320 with 3 sentences (a batch size of 3) is used as an example. The longest sentence contains 5 word tokens while the other two have 2 and 4 words. The height of the sample input tensor is 3, which is equal to the hidden dimension.

If the conventional method was used to pad all sentences to the maximal sequence length by filling zeros, the padded input tensor 310 would be generated. The elements, either 1 or 0, of the mask matrix 330 correspond respectively to a valid token or a padded token of the padded input tensor 330 with variable sequence length. By calculating the prefix sum of the mask matrix, the padded tokens are skipped and the position indices of all valid tokens are provided in the position offset information 350. An efficient kernel may be implemented to calculate the prefix sum and the position offset information 350.

As shown in the thread map 340, each warp computes the prefix sum for tokens of a whole sentence, so in total there are batch_size warps assigned in each thread block for prefix sum calculation. Once the prefix sum is computed, the input tensor 320 may be packed to a continuous memory area so that a packed input tensor 370 is generated and the total number of words used in future calculations is reduced from seq_len×batch_size to the actual valid word count of the packed tensor.

The padding-free algorithm is described above with reference to FIG. 3. It is to be noted that the batch size and sequence length shown are examples without any limitation to the protection scope.

By utilizing the padding-free algorithm of the present disclosure, processing of the Transformer can be enhanced without introducing useless computation on the padded elements. FIG. 2C illustrates a schematic diagram of Transformer encoder architecture with kernel fusion and padding-free optimization. The example of FIG. 2C presents the detailed modifications on BERT by introducing the padding-free algorithm.

Before conducting the positioning encoding, the prefix sum of the mask matrix may be calculated to pack the input tensor so that computations on useless tokens are avoided in the first GEMM at block 248. Specifically, at block 246. the prefix sum is computed and padding-free is performed. At block 248. the packed input tensors (Q, K, V) is computed in one GEMM.

In the example of FIG. 2C, since batched GEMM in MHA requires identical problem shapes among different inputs, the tensor is unpacked before entering the attention module. Once the MHA is completed, the output tensor is packed again such that all remaining operations can benefit from the padding-free algorithm. It is to be noted that padding and remove padding operations are fused with memory-bound footprints, such as adding bias and transposing, to minimize the overhead led by this feature.

As shown in FIG. 2C, at block 250. fused rebuild padding and bias adding are performed to unpack the tensor to be applied MHA. Self-attention is applied to the unpacked tensor at the MHA module 206. as described above.

At block 252. fused padding-free and transposing are performed the output tensor of the MHA module 206. At block 254, GEMM is performed on the packed tensor without padding. Further, at block 256, fused GEMM with bias adding and layer normalization is performed on the packed tensor without padding. At block 258, fused GEMM with bias adding and activation is performed on the packed tensor without padding. At block 260, GEMM is performed on the packed tensor without padding. At block 262, fused GEMM with bias adding and layer normalization is performed on the packed tensor without padding.

The padding-free algorithm according to some embodiments of the present disclosure is designed to ensure semantic preservation. An array that stores the mapping relationship of the valid tokens between the original tensor and the packed tensor is maintained. The Transformer operates on the packed tensor, and intermediate operations, such as MHA, layer normalization and activation, refer to this position array to ensure the correctness. At the end of each layer, the output tensor is reconstructed according to the position array such that the whole pipeline is semantic preserving.

TABLE 1

| | Baseline | Zero Padding | Zero Padding + fused MHA |
|---|---|---|---|
| GEMMO | 6mk² | 6(α · m)k² | 6(α · m)k² |
| MHA | $4 \frac{{m}^{2}}{bs} k$ | $4 \frac{{m}^{2}}{bs} k$ | $4 \frac{{( α \cdot m )}^{2}}{bs} k$ |
| GEMM1 | 2mk² | 2(α · m)k² | 2(α · m)k² |
| GEMM2 | 8mk² | 8(α · m)k² | 8(α · m)k² |
| GEMM3 | 8mk² | 8(α · m)k² | 8(α · m)k² |

Table 1 shows the computation number needed for variable length inputs, where average sequence length=α×maximum, m denotes batch_size×max_seq_len, k denotes the hidden dimension head_num×head_size, bs denotes the batch size.

Table 1 counts the floating-point computations of a single layer BERT Transformer. The computations of memory-bound operations are not included since they are negligible compared with the listed modules. Enabling the padding-free algorithm eliminates redundant computations for all compute-intensive modules other than MHA due to the restrictions of batched GEMM. When the average sequence length is equal to 60% of the maximum, turning on the padding-free algorithm further accelerates the BERT Transformer by 24.7%.

### Optimization of Multi-Head Attention

In the example of FIG. 2C, the padding-free algorithm effectively reduces wasted calculations for variable-length inputs. However, GEMM operations in MHA still cannot benefit from the padding-free algorithm. In other words, GEMM operations in the MHA have redundant calculations, which would become increasingly significant when the sequence length increases, as demonstrated in Table 1. The complexity of MHA is quadratic to the sequence length, while the complexity of all other GEMMs is linear to the sequence length. Given that, it is necessary to provide a high-performance MHA while maintaining the benefits of the padding-free algorithm to avoid the redundant calculations on useless tokens.

To this end, the MHA may be optimized to avoid useless calculations. Some example embodiments with respect to the optimization of the MHA are described below. In such embodiments, a tensor to be applied MHA is also referred to as an input tensor. The input tensor may represent a batch of inputs with variable sequence lengths. Another tensor output after MHA is also referred to as an output tensor or target tensor. The input tensor and the output tensor may have a dimension of batch_size×seq_len×hidden_dim, respectively, which is equal to a dimension of batch_size×seq_len×head_num×head_size. A transposing may be performed on the input tensor and the transposed input tensor may have a dimension of batch_size×head_num×seq_len×head_size. Accordingly, based on the batch size of the input tensor and the head number of the MHA, the input tensor may be divided into a plurality of matrices, specifically matrices with a number of batch_size×head_num. A matrix of the plurality of matrices has a dimension of seq_len×head_size. As a result, the computation of Q×K (which is denoted as P=Q×K) in the MHA may be divided into batch_size×head_num problems of GEMM. Similarly, the computation of P×V in the MHA may be also divided into batch_size×head_num problems of GEMM.

In some embodiments, if a maximum sequence length of the input tensor is below a threshold, the attention may be applied to the input tensor by using a single kernel. The GEMM for Q×K, the GEMM for P×V and the softmax operation may be fused into this kernel, which may be referred to as MHA computation kernel. Accordingly, the attention to the matrix of the plurality of matrices may be applied using a shared memory associated with a thread allocated for the further matrix.

For example, an unpadded fused MHA may be used for short input sequences. For short input sequences, the intermediate matrix P is held in shared memory and registers throughout the MHA computation kernel to fully eliminate the quadratic memory overhead. Q, K, and V tensors are accessed according to the positioning information obtained in the prefix sum calculation step (as described with reference to FIG. 3) to avoid redundant calculations on padding zeros for the MHA module.

For example, a 3-dimensional grid map may be launched for the fused MHA for short sequences launches: {head _num, seq_len/split_seq_len, batch_size}. Here split_seq_len is a user-defined parameter to determine the size of a sequence tile preceded by a thread block. The warp count of a thread block is computed by the maximal sequence length denoted as max_seq_len: split_seq_len/16×(max_seq_len/16). Each thread block loads a chunk of Q (max_seq_len×head_size), K (head_size×max_seq_len) and V (max_seq_len×head_size) into the shared memory and computes MHA for a tile of the resulting tensor. Three shared-memory buffers are allocated to hold Q, K, V sub-matrices. Due to the algorithmic nature of the MHA, the K and V chunks may be re-used in the same shared-memory buffer. The intermediate matrix of MHA may be held and re-used in another pre-allocated shared-memory buffer.

The workflow of fused MHA for short sequences is straightforward yet efficient. For example, each thread may first load its own tile of Q and K into the shared memory and computes GEMM for P=Q×K. The element-wise adding bias and scaling operations may be both fused with the load process to hide the memory latency. GEMM is computed using the any suitable interface of the processing device (for example, GPU) to leverage tensor cores of the processing device. The intermediate matrix P may be held in shared memory during the reduction. Because this fused MHA is designed for short sequences, each thread can load a whole sequence of P from the shared memory into register files for both reduction and element-wise exponential transform in the softmax operation. Once the softmax operation is completed, a K tile is loaded to the shared memory to compute the second GEMM O=P×V, and then the result tensor O is stored to the global memory.

Given the limited resources of register files and shared memory, the fused MHA for short sentence may be no longer feasible for long sequences exceeding the length threshold. Accordingly, in some embodiments of the present disclosure, a grouped matrix multiplication (e.g., grouped GEMM) may be used to apply MHA to the input tensor with long sequences. A resulting matrix of the grouped matrix multiplication may comprise a plurality of tiles each of which is computed by a set of threads with a shared memory.

To better understand the present disclosure, a brief introduction is now made to grouped GEMM as example of grouped matrix multiplication. Different from batched GEMM, where all GEMM sub-problems are required to have an identical shape, grouped GEMM allows arbitrary shapes for sub-problems. This is enabled by a built-in scheduler that iterates over all GEMM sub-problems in a round-robin manner.

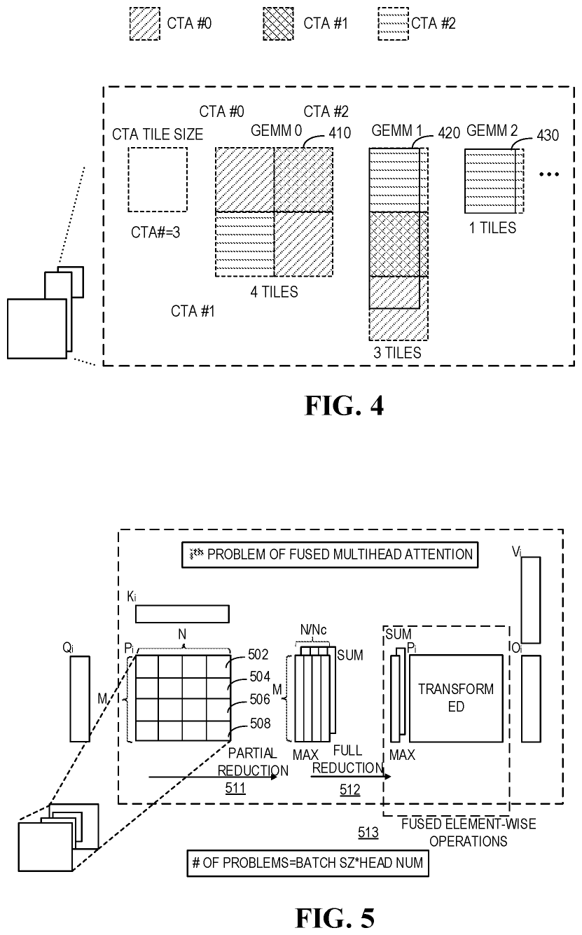

FIG. 4 demonstrates example operations of the grouped GEMM using an example with 3 sub-problems. FIG. 4 shows three resulting matrices 410, 420 and 430 of GEMM, each of which is divided according to the tiling size of the thread block. Supposing 3 thread blocks (including CTA #0, CTA #1 and CTA #2) are launched, and each CTA calculates a fix-sized CTA tile at each step until all GEMM sub-problems have been covered. GPU computes in waves, logically. In the first wave, all the three CTAs calculate 3 tiles (shown in different shadowing patterns in FIG. 4). And then in the second CTA wave, CTA #0 moves to the bottom-right tile of GEMM 1 while CTA #1 and CTA #2 move to sub-problems of GEMM 1. In the final CTA wave, CTA #0 and CTA #1 continue to compute tasks in GEMM 1 and GEMM 2 while CTA #2 keeps idle because there are no more available tiles in the computational graph.

Since grouped GEMM lifts the restriction on the shape of sub-problems, it can directly benefit MHA problems with variable-length inputs. The total number of MHA problems is equal to batch_size×head_num. The MHA problems among different batches may have different sequence lengths, while sequence lengths within the same batch may be identical. The grouped GEMM scheduler iterates over all attention units in a round-robin manner. In each attention unit, GEMM Pᵢ=Qᵢ×Kᵢ is first computed, and the softmax operation may be performed on Pᵢ. The second GEMM Oᵢ=Pᵢ×Vᵢ provides the final attention result. Here i indicates the i^{th} problem of grouped MHA with variable shapes.

When using the grouped GEMM to implement attention, the number of matrix multiplication problems in batch_size×head_num may be large. Reading size information of the problems incurs significant overhead because from a threading perspective, each thread needs to traverse and read size information of all the problems.

In some embodiments, size information for some problems may be shared. For example, size information may be shared among matrices of the plurality of matrices (to be computed by grouped GEMM) corresponding to an input of the batch of inputs. For the same input, the sequence length for different heads is the same, and the problem size is also the same. By sharing, the parameter storage is reduced from batch_size×head_num to batch_size.

In another aspect, the grouped GEMM frequently checks with the built-in scheduler on the current task assignments, which leads to the runtime overhead. To address this issue, the grouped GEMM scheduler may be optimized.

To this end, in some embodiments of the present disclosure, parameters of a matrix multiplication problem, or in other words size information about the matrix to be computed, may be read by a thread of warp and shared with another thread of the warp through the inter-thread communication.

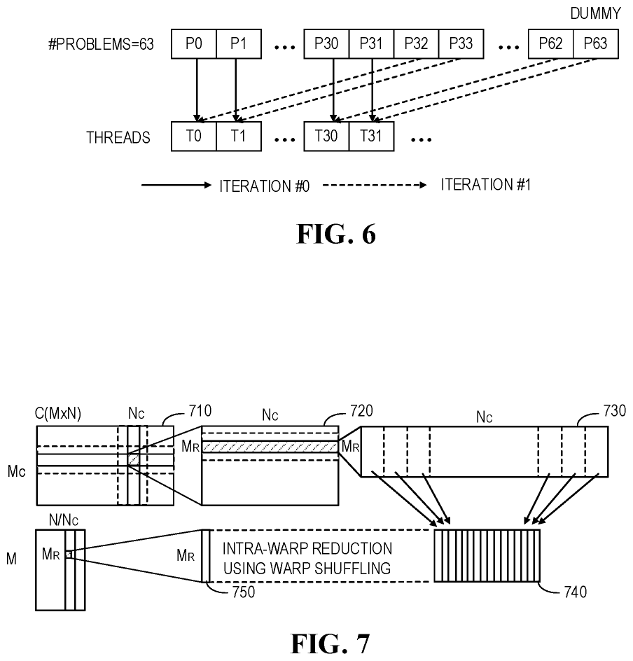

FIG. 6 shows the optimization for the original grouped GEMM scheduler. In the example as shown in FIG. 6, the warp includes 32 threads, from T0, T1, to T30 and T31 and there are 63 problems. In the iteration #0, each thread of T0, T1, to T30 and T31 may read size information of a problem of the 63 problem and may share the size information with the other 31 threads. Thus, size information of the first 32 problems may be read. In the iteration #1, each thread of T0, T1, to T30 and T31 may read size information of a problem of the reaming problems (it is be noted that the thread T31 may read dummy size information) and may share the size information with the other 31 threads. As can be seen, rather than asking one thread to compute the current tasks metadata, there are all 32 threads in a warp compute the tile indices to visit at one time. Therefore, it can reduce the scheduler visit overhead by 32.

In order to further improve performance, the softmax operation after Q×K may be fused with matrix multiplication, which saves memory access operations for intermediate matrices compared to a separate kernel for the softmax operation.

Because the softmax operation needs to reduce the entire row of data, but because of the size limit of the shared memory, a thread block cannot process the entire row of data, and the communication between thread blocks is inefficient, the entire softmax operation cannot be completed within the epilogue for computing Q×K. In some embodiments, the softmax operation may be split into three steps. The first step may be fused into the epilogue of Q×K, the third step may be fused into the prologue of P×V, and a lightweight kernel may be added in the middle to implement the second step.

Reference is now made to FIG. 5. At the first step 511, partial reduction may be performed. For example, the intermediate matrix Pi may be divided into M×N intermediate tiles, for example the intermediate tiles 502, 504, 506 and 508. In the example, M=4 and N=4. For an intermediate tile of the plurality of intermediate tiles, a partial reduction result of the softmax operation along rows of the intermediate tile may be determined. The partial reduction result may include a maximum value along a row of the intermediate tile. In an example, maxⱼ=max(x₀, . . . , xₙ), where j denotes the tile along the row direction of Pi, and xₜ (t=0, n) denotes a value of an element with a column index t in a row. The partial reduction result may include a sum of exponents of differences between values along the row of the intermediate tile and the maximum value. For example, sumⱼ=e^{x}^{₀}^{-max}^{ⱼ}+ . . . +e^{x}^{ₙ}^{-max}^{ⱼ}. For example, maxⱼ and sumⱼ may be computed in the epilogue for Q×K.

At the second step 512, the full reduction may be performed for example by using a separated kernel. Specifically, the full reduction result of the softmax operation along rows of the intermediate matrix may be determined based on the respective partial reduction results determined for the plurality of intermediate tiles. For example, max=max(max₀, . . . , max_{N}), and sum=Σⱼsumⱼ*e^{max}^{ⱼ}^{-max}.

At the third 513, the fused element-wise operation may be performed in a single kernel. Specifically, by using the kernel, the intermediate matrix Pi may be transformed based on the full reduction result. For example,

$${softmax}_{i} = \frac{{e}^{{x}_{i}} - max}{sum} .$$

Then, the grouped matrix multiplication may be performed on the transformed intermediate matrix Pi and a value of the matrix. As shown in FIG. 5, the transformed Pi is multiplexed with a value matrix Vi to get the matrix Oi as a result of the MHA.

Taking the grouped GEMM for example, the memory footprints of the softmax operation may be fused into two grouped GEMMs of the MHA. FIG. 7 shows an example of epilogue fusion for softmax reduction. The resulting matrix 710 of the grouped GEMM has a dimension of M×N. A CTA computes an M_{C}×N_{C} sub-matrix 720. For example, M_{C} and N_{C} may be both set to 128 to maximize the performance of the grouped GEMM. In this case, according to thread map assignment, there are 128 threads per CTA, and the thread map is arranged as 8×16, where each thread holds a 128-bit register tile in each step. After the intra-thread reduction, the M_{R}×N_{C} (8×128) sub-matrix 730 is reduced to 8×16 matrix 740, with one reduced result held by one thread.

An intra-warp reduction is conducted to further reduce 8×16 matrix 740 from the column dimension to the vector 750, which may be implemented via warp shuffling for efficiency. Similar reductions (intra-thread followed by intra-warp reduction) may be performed to compute both max and sum in epilogue. Once max and sum are both reduced, they are stored to global memory.

In these embodiments, the MHA is optimized by fusing the softmax operation into GEMMs without calculating for useless padded tokens under variable-length inputs. For short sequences, the intermediate matrix is held in registers and shared memory. For long sequences, a grouped GEMM based fused MHA is adopted and softmax operations are fused into the customized GEMM epilogue to hide the memory latency. In both implementations, the input matrices are accessed according to the position information obtained from the padding-free algorithm so that no redundant calculations are introduced.

The reduction in the epilogue only provides with partial reduction within a thread block because cross-thread block communication is impractical under the current GPU programming model. Hence, it is necessary to launch a separated lightweight kernel, as shown in FIG. 5, to conduct the full reduction. In the partial reduction, the target tensor of each attention unit is seq_len×seq_len while the full reduction just reduces a seq_len×seq_len/128. Therefore, the workload of full reduction is negligible to that of partial reduction. In practice, the full reduction kernel only accounts for ˜2% of total execution time in fused MHA.

Once the fully reduced max and sum vectors have been obtained, it is ready to proceed element-wise transform

$$\frac{{e}^{{x}_{ij}} - max}{sum}$$

on the first GEMM's output matrix. To hide the sum memory latency, these element-wise operations are fused into the main loop of the second GEMM.

The baseline MHA is a computational chain containing a batched GEMM, a softmax, and another batched GEMM. The time and memory complexity of all these operations are quadratic in the sequence length. Because the padding-free algorithm directly reduces the effective sequence length, MHA with variable-length input also gains a direct improvement.

The fused MHA according to embodiments of the present disclosure, which is explicitly designed to handle both short and long sequences, incorporates the padding-free algorithm to alleviate the memory overhead of the intermediate matrix in MHA caused by padding for variable-length inputs. For example, the highly optimized MHA can accelerate the single-layer BERT Transformer by 19% compared to the previous step. As a result, this fully optimized version surpasses the baseline implementation in FIG. 2A by 60%, and the remaining operations of a forward BERT Transformer are all near-optimal GEMM operations.

In view of the above, the present disclosure presents a solution for tensor processing, in particular a solution for applying attention. This solution is optimized for variable-length sequences and thus has high-performance. This optimized solution not only brings algorithmic level innovation that frees the attention mechanism from padding overhead, but also incorporates architecture-aware optimizations to accelerate functioning modules of the attention mechanism. The optimized fused MHA, as well as other step-wise optimizations, together provide with significant speedup over current state-of-the-art models based on attention mechanism. Moreover, although the example embodiments are described with respect to BERT, it is just an example. The solution is applicable to any model with an attention mechanism. Further, although the above example embodiments are described with respect to NLP, the solution can be applied to any data processing, for example, image or digital data.

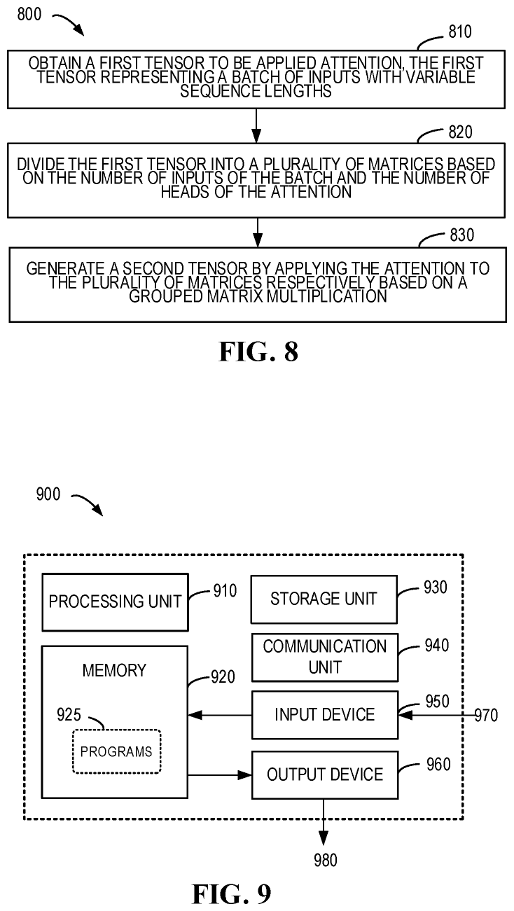

The above paragraphs have described details for the tensor processing. According to some embodiments of the present disclosure, a method is provided for tensor processing. Reference will be made to FIG. 8 for more details about the method. FIG. 8 illustrates an example flowchart of a method 800 for tensor processing according to some embodiments of the present disclosure.

At a block 810, a first tensor is obtained to be applied attention, the first tensor representing a batch of inputs with variable sequence lengths. At a block 820, the first tensor is divided into a plurality of matrices based on the number of inputs of the batch and the number of heads of the attention. A matrix of the plurality of matrices has a dimension corresponding to the sequence length of an input of the batch and a dimension corresponding to a head size of the attention. At a block 830, a second tensor is generated by applying the attention to the plurality of matrices respectively based on a grouped matrix multiplication (for example, the grouped GEMM). A resulting matrix of the grouped matrix multiplication comprises a plurality of tiles each of which is computed by a set of threads with a shared memory.

In some embodiments of the present disclosure, applying the attention to the plurality of matrices comprises: for the matrix of the plurality of matrices, performing the grouped matrix multiplication on a query of the matrix (denoted as Q) and a key of the matrix (denoted as K) to generate an intermediate matrix, wherein the intermediate matrix comprises a plurality of intermediate tiles each of which is computed by the set of threads with the shared memory; determining a full reduction result of a softmax operation based on the plurality of intermediate tiles; transforming the intermediate matrix based on the full reduction result; and performing the grouped matrix multiplication on the transformed intermediate matrix and a value of the matrix ((denoted as V)).

In some embodiments of the present disclosure, determining a full reduction result of a softmax operation comprises: determining, for an intermediate tile of the plurality of intermediate tiles, a partial reduction result of the softmax operation along rows of the intermediate tile; and determining the full reduction result of the softmax operation along rows of the intermediate matrix based on the respective partial reduction results determined for the plurality of intermediate tiles.

In some embodiments of the present disclosure, the partial reduction result comprises at least one of: a maximum value along a row of the intermediate tile, or a sum of exponents of differences between values along the row of the intermediate tile and the maximum value.

In some embodiments of the present disclosure, size information is shared among matrices of the plurality of matrices corresponding to an input of the batch of inputs.

In some embodiments of the present disclosure, the set of threads comprises a plurality groups of threads, and threads in a group of threads of the plurality groups of threads are configured with inter-thread communication within the group of threads, and size information about the matrix is read by a thread of the group of threads and shared with another thread of the group of threads through the inter-thread communication.

In some embodiments of the present disclosure, generating the second tensor by applying the attention to the plurality of matrices respectively based on the grouped matrix multiplication is response to: an upper sequence length of sequence lengths of the batch of inputs exceeds a length threshold.

In some embodiments of the present disclosure, the method 800 further comprises: obtaining a third tensor to be applied attention, the third tensor representing a further batch of inputs with variable sequence lengths; dividing the third tensor into a plurality of further matrices based on the number of inputs of the further batch and the number of heads of the attention, wherein a further matrix of the plurality of further matrices has a dimension corresponding to the sequence length of an input of the further batch and a dimension corresponding to the head size of the attention; and in response to an upper sequence length of sequence lengths of the further batch of inputs is below the length threshold, generating a fourth tensor by applying the attention to plurality of further matrices, wherein the attention to the further matrix is applied using a shared memory associated with a thread allocated for the further matrix.

In some embodiments of the present disclosure, the attention is part of a model based on Transformer.

According to some embodiments of the present disclosure, an apparatus is provided for tensor processing. The apparatus comprises: an obtaining module, being configured for obtaining a first tensor to be applied attention, the first tensor representing a batch of inputs with variable sequence lengths; a dividing module, being configured for dividing the first tensor into a plurality of matrices based on the number of inputs of the batch and the number of heads of the attention, wherein a matrix of the plurality of matrices has a dimension corresponding to the sequence length of an input of the batch and a dimension corresponding to a head size of the attention; and a generating module, being configured for generating a second tensor by applying the attention to the plurality of matrices respectively based on a grouped matrix multiplication, wherein a resulting matrix of the grouped matrix multiplication comprises a plurality of tiles each of which is computed by a set of threads with a shared memory. Further, the apparatus may comprise other units for implementing other steps in the above method.

According to some embodiments of the present disclosure, an electronic device is provided for implementing the above method. The electronic device comprises: a computer processor coupled to a computer-readable memory unit, the memory unit comprising instructions that when executed by the computer processor implements a method for tensor processing. The method comprises: obtaining a first tensor to be applied attention, the first tensor representing a batch of inputs with variable sequence lengths; dividing the first tensor into a plurality of matrices based on the number of inputs of the batch and the number of heads of the attention, wherein a matrix of the plurality of matrices has a dimension corresponding to the sequence length of an input of the batch and a dimension corresponding to a head size of the attention; and generating a second tensor by applying the attention to the plurality of matrices respectively based on a grouped matrix multiplication, wherein a resulting matrix of the grouped matrix multiplication comprises a plurality of tiles each of which is computed by a set of threads with a shared memory.

In some embodiments of the present disclosure, applying the attention to the plurality of matrices comprises: for the matrix of the plurality of matrices, performing the grouped matrix multiplication on a query of the matrix and a key of the matrix to generate an intermediate matrix, wherein the intermediate matrix comprises a plurality of intermediate tiles each of which is computed by the set of threads with the shared memory; determining a full reduction result of a softmax operation based on the plurality of intermediate tiles; transforming the intermediate matrix based on the full reduction result; and performing the grouped matrix multiplication on the transformed intermediate matrix and a value of the matrix.

In some embodiments of the present disclosure, determining a full reduction result of a softmax operation comprises: determining, for an intermediate tile of the plurality of intermediate tiles, a partial reduction result of the softmax operation along rows of the intermediate tile; and determining the full reduction result of the softmax operation along rows of the intermediate matrix based on the respective partial reduction results determined for the plurality of intermediate tiles.

In some embodiments of the present disclosure, the partial reduction result comprises at least one of: a maximum value along a row of the intermediate tile, or a sum of exponents of differences between values along the row of the intermediate tile and the maximum value.

In some embodiments of the present disclosure, size information is shared among matrices of the plurality of matrices corresponding to an input of the batch of inputs.

In some embodiments of the present disclosure, the set of threads comprises a plurality groups of threads, and threads in a group of threads of the plurality groups of threads are configured with inter-thread communication within the group of threads, and size information about the matrix is read by a thread of the group of threads and shared with another thread of the group of threads through the inter-thread communication.

In some embodiments of the present disclosure, generating the second tensor by applying the attention to the plurality of matrices respectively based on the grouped matrix multiplication is response to: an upper sequence length of sequence lengths of the batch of inputs exceeds a length threshold.

In some embodiments of the present disclosure, the method further comprises: obtaining a third tensor to be applied attention, the third tensor representing a further batch of inputs with variable sequence lengths; dividing the third tensor into a plurality of further matrices based on the number of inputs of the further batch and the number of heads of the attention, wherein a further matrix of the plurality of further matrices has a dimension corresponding to the sequence length of an input of the further batch and a dimension corresponding to the head size of the attention; and in response to an upper sequence length of sequence lengths of the further batch of inputs is below the length threshold, generating a fourth tensor by applying the attention to plurality of further matrices, wherein the attention to the further matrix is applied using a shared memory associated with a thread allocated for the further matrix.

In some embodiments of the present disclosure, the attention is part of a model based on Transformer.

According to some embodiments of the present disclosure, a computer program product, the computer program product comprising a computer readable storage medium having program instructions embodied therewith, the program instructions executable by an electronic device to cause the electronic device to perform the method 800.

FIG. 9 illustrates a block diagram of a computing device 900 in which various some embodiments of the present disclosure can be implemented. It would be appreciated that the computing device 900 shown in FIG. 9 is merely for purpose of illustration, without suggesting any limitation to the functions and scopes of the present disclosure in any manner. The computing device 900 may be used to implement the above method 800 in some embodiments of the present disclosure. As shown in FIG. 9, the computing device 900 may be a general-purpose computing device. The computing device 900 may at least comprise one or more processors or processing units 910, a memory 920, a storage unit 930, one or more communication units 940, one or more input devices 950, and one or more output devices 960.

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller, or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk, or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem, and the like) enabling the computing device 900 to communicate with one or more other computing devices, if required. Such communication can be performed via input/output (I/O) interfaces (not shown).

In some implementations, instead of being integrated in a single device, some, or all components of the computing device 900 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

1. A method for tensor processing, comprising:
obtaining a first tensor to be applied attention, the first tensor representing a batch of inputs with variable sequence lengths;
dividing the first tensor into a plurality of matrices based on the number of inputs of the batch and the number of heads of the attention, wherein a matrix of the plurality of matrices has a dimension corresponding to the sequence length of an input of the batch and a dimension corresponding to a head size of the attention; and
generating a second tensor by applying the attention to the plurality of matrices respectively based on a grouped matrix multiplication, wherein a resulting matrix of the grouped matrix multiplication comprises a plurality of tiles each of which is computed by a set of threads with a shared memory.

2. The method of claim 1, wherein applying the attention to the plurality of matrices comprises:
for the matrix of the plurality of matrices,
performing the grouped matrix multiplication on a query of the matrix and a key of the matrix to generate an intermediate matrix, wherein the intermediate matrix comprises a plurality of intermediate tiles each of which is computed by the set of threads with the shared memory;
determining a full reduction result of a softmax operation based on the plurality of intermediate tiles;
transforming the intermediate matrix based on the full reduction result; and
performing the grouped matrix multiplication on the transformed intermediate matrix and a value of the matrix.

3. The method of claim 2, wherein determining a full reduction result of a softmax operation comprises:
determining, for an intermediate tile of the plurality of intermediate tiles, a partial reduction result of the softmax operation along rows of the intermediate tile; and
determining the full reduction result of the softmax operation along rows of the intermediate matrix based on the respective partial reduction results determined for the plurality of intermediate tiles.

4. The method of claim 3, wherein the partial reduction result comprises at least one of:
a maximum value along a row of the intermediate tile, or
a sum of exponents of differences between values along the row of the intermediate tile and the maximum value.

5. The method of claim 1, wherein size information is shared among matrices of the plurality of matrices corresponding to an input of the batch of inputs.

6. The method of claim 1, wherein the set of threads comprises a plurality groups of threads, and threads in a group of threads of the plurality groups of threads are configured with inter-thread communication within the group of threads, and
size information about the matrix is read by a thread of the group of threads and shared with another thread of the group of threads through the inter-thread communication.

7. The method of claim 1, wherein generating the second tensor by applying the attention to the plurality of matrices respectively based on the grouped matrix multiplication is response to:
an upper sequence length of sequence lengths of the batch of inputs exceeds a length threshold.

8. The method of claim 7, further comprising:
obtaining a third tensor to be applied attention, the third tensor representing a further batch of inputs with variable sequence lengths;
dividing the third tensor into a plurality of further matrices based on the number of inputs of the further batch and the number of heads of the attention, wherein a further matrix of the plurality of further matrices has a dimension corresponding to the sequence length of an input of the further batch and a dimension corresponding to the head size of the attention; and
in response to an upper sequence length of sequence lengths of the further batch of inputs is below the length threshold, generating a fourth tensor by applying the attention to plurality of further matrices, wherein the attention to the further matrix is applied using a shared memory associated with a thread allocated for the further matrix.

9. The method of claim 1, wherein the attention is part of a model based on Transformer.

10. An electronic device, comprising a computer processor coupled to a computer-readable memory unit, the memory unit comprising instructions that when executed by the computer processor implements a method for tensor processing, comprising:
obtaining a first tensor to be applied attention, the first tensor representing a batch of inputs with variable sequence lengths;
dividing the first tensor into a plurality of matrices based on the number of inputs of the batch and the number of heads of the attention, wherein a matrix of the plurality of matrices has a dimension corresponding to the sequence length of an input of the batch and a dimension corresponding to a head size of the attention; and
generating a second tensor by applying the attention to the plurality of matrices respectively based on a grouped matrix multiplication, wherein a resulting matrix of the grouped matrix multiplication comprises a plurality of tiles each of which is computed by a set of threads with a shared memory.

11. The electronic device of claim 10, wherein applying the attention to the plurality of matrices comprises:
for the matrix of the plurality of matrices,
performing the grouped matrix multiplication on a query of the matrix and a key of the matrix to generate an intermediate matrix, wherein the intermediate matrix comprises a plurality of intermediate tiles each of which is computed by the set of threads with the shared memory;
determining a full reduction result of a softmax operation based on the plurality of intermediate tiles;
transforming the intermediate matrix based on the full reduction result; and
performing the grouped matrix multiplication on the transformed intermediate matrix and a value of the matrix.

12. The electronic device of claim 11, wherein determining a full reduction result of a softmax operation comprises:
determining, for an intermediate tile of the plurality of intermediate tiles, a partial reduction result of the softmax operation along rows of the intermediate tile; and
determining the full reduction result of the softmax operation along rows of the intermediate matrix based on the respective partial reduction results determined for the plurality of intermediate tiles.

13. The electronic device of claim 12, wherein the partial reduction result comprises at least one of:
a maximum value along a row of the intermediate tile, or
a sum of exponents of differences between values along the row of the intermediate tile and the maximum value.

14. The electronic device of claim 10, wherein size information is shared among matrices of the plurality of matrices corresponding to an input of the batch of inputs.

15. The electronic device of claim 10, wherein the set of threads comprises a plurality groups of threads, and threads in a group of threads of the plurality groups of threads are configured with inter-thread communication within the group of threads, and
size information about the matrix is read by a thread of the group of threads and shared with another thread of the group of threads through the inter-thread communication.

16. The electronic device of claim 10, wherein generating the second tensor by applying the attention to the plurality of matrices respectively based on the grouped matrix multiplication is response to:
an upper sequence length of sequence lengths of the batch of inputs exceeds a length threshold.

17. The electronic device of claim 16, further comprising:
obtaining a third tensor to be applied attention, the third tensor representing a further batch of inputs with variable sequence lengths;
dividing the third tensor into a plurality of further matrices based on the number of inputs of the further batch and the number of heads of the attention, wherein a further matrix of the plurality of further matrices has a dimension corresponding to the sequence length of an input of the further batch and a dimension corresponding to the head size of the attention; and
in response to an upper sequence length of sequence lengths of the further batch of inputs is below the length threshold, generating a fourth tensor by applying the attention to plurality of further matrices, wherein the attention to the further matrix is applied using a shared memory associated with a thread allocated for the further matrix.

18. The electronic device of claim 10, wherein the attention is part of a model based on Transformer.

19. A computer program product, the computer program product comprising a computer readable storage medium having program instructions embodied therewith, the program instructions executable by an electronic device to cause the electronic device to perform a method for tensor processing, comprising:
obtaining a first tensor to be applied attention, the first tensor representing a batch of inputs with variable sequence lengths;
dividing the first tensor into a plurality of matrices based on the number of inputs of the batch and the number of heads of the attention, wherein a matrix of the plurality of matrices has a dimension corresponding to the sequence length of an input of the batch and a dimension corresponding to a head size of the attention; and
generating a second tensor by applying the attention to the plurality of matrices respectively based on a grouped matrix multiplication, wherein a resulting matrix of the grouped matrix multiplication comprises a plurality of tiles each of which is computed by a set of threads with a shared memory.

20. The computer program product of claim 19, wherein applying the attention to the plurality of matrices comprises:
for the matrix of the plurality of matrices,
performing the grouped matrix multiplication on a query of the matrix and a key of the matrix to generate an intermediate matrix, wherein the intermediate matrix comprises a plurality of intermediate tiles each of which is computed by the set of threads with the shared memory;
determining a full reduction result of a softmax operation based on the plurality of intermediate tiles;
transforming the intermediate matrix based on the full reduction result; and
performing the grouped matrix multiplication on the transformed intermediate matrix and a value of the matrix.
